(19) United States
(12) Patent Application Publication
(10) Pub. No.: US 2007/0294710 A1
(43) Pub. Date: Dec. 20, 2007

(54) Simple bluetooth software development kit

(75) Inventor: Scott Meesseman, Warren, MI (US)

Correspondence Address: BRINKS HOFER GILSON & LIONE, P.O. BOX 10395, CHICAGO, IL, 60610, US

(73) Assignee: ALPS Automotive Inc.

(21) Appl. No.: 11/455,953

(22) Filed: Jun. 19, 2006

(51) Int. Cl. G06F 9/46

(52) U.S. Cl. 719/328

(57) ABSTRACT

A software tool and method implementing an application program interface (API) for adding Bluetooth wireless functionality to a user interface module are provided. The A software development kit (SDK) provides a layered framework that defines a plurality of interacting software layers for communicating data and commands between a user interface module and a Bluetooth communications stack. The SDK includes a number of pre-coded API function modules for implementing various interface functions. A plurality of pre-coded Bluetooth function mapping instruction sets are provided for mapping function calls from the API function modules to the Bluetooth communications stack. The layered framework may include an API layer; a Bluetooth adaption layer, a PIM module or PIM adaption layer, and a voice recognition/text-to-speech module. The API function modules are identified and exposed in a Bluetooth API layer according to a simplified command syntax associated with the SDK.

### BACKGROUND

1. Technical Field

The present invention relates to a software development kit for adding Bluetooth wireless communications functions to user interface applications.

2. Background Information

Wireless communications networks, such as Bluetooth networks, are increasingly used in many platforms and applications. Automobile interfaces, or other environments which may require “hands-free” or wireless communication, often use the Bluetooth communications protocol to interface portable and vehicle-mounted electronic devices.

Bluetooth application programming has become an increasingly costly investment for companies, especially in the automotive sector. With the current complexity of software systems in a telematics-enabled vehicle (i.e. NAVI), the dedication of resources to that of Bluetooth applications has become burdensome. User interface developers may not possess the current capability to easily add complex Bluetooth functionality into their systems, or they may not have the resources to do so.

At the same time, demand for Bluetooth enabled devices is increasing. personal computers and portable electronic devices such as cell phones, personal digital assistants (PDAs), and wireless email terminals have become an indispensable part of everyday life for many people. It is not uncommon for individuals to employ multiple devices for managing their personal communications, schedules, address books, contact lists, task lists, and the like. Consumers often want, if not expect, their state-of-the-art electronic devices to work together, sharing data and controlling one another over seamless wireless networks.

At present, the user interface developers tasked with developing the application programs for implementing such seamless and wireless interoperability must have access to and a thorough working knowledge of the underlying connection, transport, data retrieval, and synchronization functions of the wireless network. Unfortunately, many user interface developers lack either the requisite knowledge of Bluetooth networks and how they operate, or simply lack the resources required to develop products having the desired wireless network functionality. In addition, user interface developers may require access to other functionality such as voice recognition and personal information management (PIM) functions. Currently, no integrated solution exists to implement all the various features needed for application development in a Bluetooth environment.

### BRIEF SUMMARY

A software tool for implementing an application program interface (API) for adding Bluetooth wireless functionality to a user interface module is provided. The software tool is provided in the form of a software development kit (SDK). The SDK provides a layered framework that defines a plurality of interacting software layers for communicating data and commands between a user interface module and a Bluetooth communications stack. The SDK includes a number of pre-coded API function modules for implementing various interface functions. A plurality of pre-coded Bluetooth function mapping instruction sets are provided for mapping function calls from the API function modules to the Bluetooth communications stack. The API function modules are identified and exposes in a Bluetooth API layer according to a simplified command syntax associated with the SDK. The layered framework may include an API layer; a Bluetooth adaption layer, a PIM module or PIM adaption layer, and a voice recognition/text-to-speech module.

A method of implementing an application program interface (API) to add Bluetooth wireless functionality to a user interface module is also provided. The API includes a multi-layered functional software architecture for communicating interface commands and data between the user interface and a Bluetooth stack. The multi-layered functional architecture includes an API layer configured to implement one or more interface functions via the Bluetooth stack, a Bluetooth adaption layer configured to implement software instructions for mapping interface commands and data between the API layer and the Bluetooth stack, and a personal information management (PIM) module adaption layer configured to implement software instructions for mapping PIM commands and data between the API layer and a PIM database associated with the user interface module. The method involves selecting API functions from a library of pre-coded API function modules adapted to provide one or more interface functions for interacting with an external device, and including the selected API function modules in the API layer. A set of pre-coded mapping instructions may be selected from a plurality of Bluetooth mapping instruction sets for mapping Bluetooth function calls from the API function modules to the Bluetooth stack. Each set of mapping instructions is adapted to interface with a Bluetooth stack provided by a particular Bluetooth provider, the selected set of mapping instructions corresponding to the particular Bluetooth stack employed in the user interface module. The selected mapping instructions may be inserted into the Bluetooth adaption layer. Similarly, a set of pre-coded PIM mapping instructions may be selected from a plurality of pre-coding PIM mapping instruction sets for mapping PIM commands from a PIM API to a PIM database. Again, each set of mapping instructions is adapted to interface with a PIM database of a particular type based on the particular type of PIM database employed by the interface module. The selected set of PIM mapping instructions may be inserted into the PIM adaption layer.

A software architecture is disclosed for implementing an application programming interface for providing Bluetooth wireless communications functionality to a user interface. The software architecture includes an API layer adapted to receive API modules implementing specific wireless communication functions. The API modules are adapted to receive input commands and data from and send output data to the user interface, and to interact with external devices via a wireless Bluetooth link. A Bluetooth adaption layer adapted to include mapping instructions for mapping generic Bluetooth function calls from the API modules of the API layer to specific Bluetooth commands associated with a specified Bluetooth stack. A PIM adaption layer may also be provided for receiving mapping instructions for mapping data and commands between the API modules and external devices and a specified PIM database included with the user interface module.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the appended claims.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a user interface.

FIG. 2 is a functional block diagram of a plurality of functional APIs.

FIG. 3 is block diagram of a software architecture provided by the SDK of the present invention.

FIG. 4 is flowchart of a method of implementing an API for providing wireless Bluetooth communications.

### DETAILED DESCRIPTION OF THE PREFERRED EMBODIMENTS

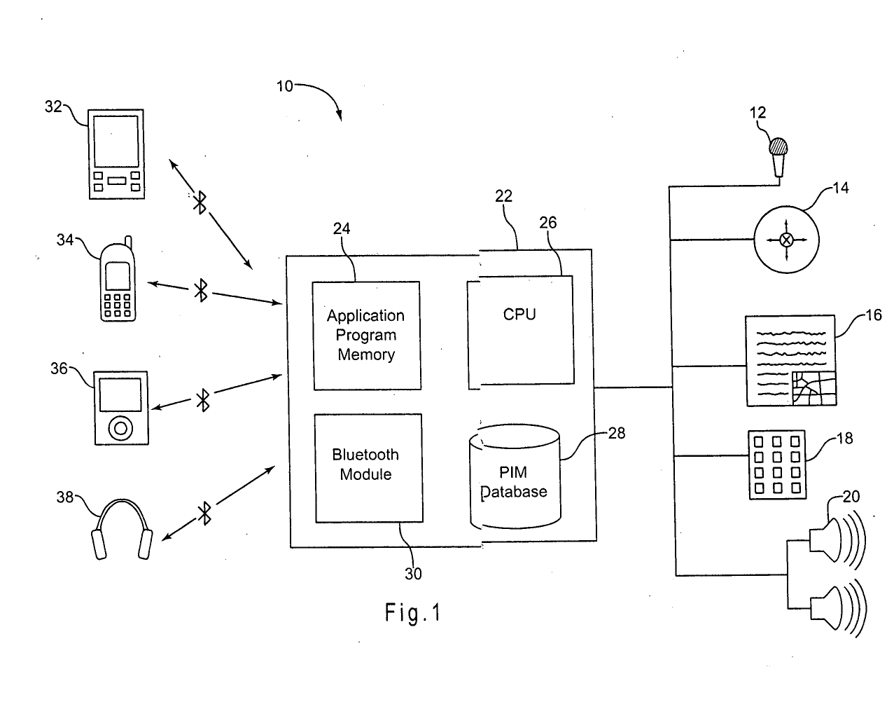

FIG. 1 is a block diagram of user interface 10. The interface 10 may be, for example, the human interface allowing a driver or other occupant of a vehicle to access and control various systems within the vehicle. The user interface includes a plurality of input and output devices by which the user interacts with various systems. In the user interface of FIG. 1, for example the input devices include a microphone 12, a multi-position haptic switch 14, and a pushbutton keypad 18. The microphone may be used to receive verbal commands that are interpreted by a voice recognition system, for receiving speech data from a user participating in a handsfree telephone call, or the like. Output devices include a visual display panel 16 and audio speakers 20. A user interacts with the various systems by entering commands and data via the various input devices, and receives data displayed on the visual display panel or audibly presented via the output speakers 20. A user interface module 22 receives and processes data from the various input devices and generates the output data presented to the user via the various output devices.

The functionality of a user interface may be greatly expanded by configuring the user interface to interact with external devices. For example the input and output devices of the user interface 10 may be employed to access data and control the operation of external mobile devices such as a personal digital assistant (PDA) 24, Cellular telephone 26, an MP3 audio player 28, or a wireless headphone set 30.

The user interface module 22 may be adapted to perform personal information management (PIM) functions whereby a user's personal information such as contact lists, events calendars task lists, and the like are stored on a database associated with the user interface module 22. The user may access data by entering commands via the microphone 12, the haptic switch 14, the pushbutton keypad 18, or some other input device provided by the interface. PIM data may be displayed on the visual display device 16 or converted to synthesized speech and played over time output speakers 20. By interacting with an external PDA device 24, the user interface module 22 may synchronize PIM data stored on the PDA with data stored on the PIM database associated with in the user interface module 22. Synchronizing the devices ensures that consistent up-to-date information is stored on both devices. Similar PIM data synchronization functions may be carried out between the user interface module 22 and a cellular telephone 26 in order to synchronize the user's phonebook data and the like.

The user interface 10 may also be configured to control the operation of external devices such as the cellular telephone 26,28, and headphones 30. Controlling a cellular phone 26 via the user interface may allow the driver of a vehicle to make hands-free telephone calls via the interface 10.

Interaction with an audio player such as the MP3 player 28 may allow audio from an alternative sources to be played over the interface's audio speakers 20. Conversely, interaction with a wireless headphone set 30 may allow audio from various audio sources such as a car radio or an in dash CD player, to be streamed to the headphones. The interaction between the interface module 22 and the various external devices may be provided by a Bluetooth wireless communication network protocol.

The user interface module 22 includes a memory 24 for storing an interface application program for implementing the various interface functions to be carried out by the interface module 22. A CPU 26 is provided for executing the interface application program stored in the memory 24. A database 28 is provided for storing data such as PIM data or other data necessary to implement the various functions provided by the interface module 22. Finally a Bluetooth module 30 provides the hardware and software for implementing Bluetooth wireless communication network for creating a wireless link between the user interface module 22 and external mobile devices.

The user interface application software stored in the memory 24 may be compartmentalized according to the various functions to be performed by the interface. For example, the interface application software may include an audio layer for controlling audio played over the interface's audio speakers. A voice recognition/text-to-speech module may be provided for interpreting verbal commands received by the microphone and translating textual information into audible speech that may be played over the interface vehicle's speakers 20. And a PIM database may be provided for storing and selectively retrieving and displaying PIM data.

In order to interact with external devices in a meaningful way over LA Bluetooth wireless network the user interface application software must be adopted to interact with a Bluetooth communication stack provided by the Bluetooth module 30. The Bluetooth stack is a layered communications software architecture for implementing wireless communications between devices according to the Bluetooth protocol API provide the software interface for managing the commands and data exchanges that pass between the user interface application software and external devices. Thus, the APIs must define the commands and data structures that will pass between the user interface module 22 and the various external devices as well as the instructions for interacting with the Bluetooth stack in order to communicate the defined commands, and data structures over the Bluetooth network. APIs interact with a Bluetooth communications stack provided by the Bluetooth module. For example, as mentioned above, the user interface module 22 may implement a PIM database, and it may be desirable to synchronize PIM data stored in the PIM database with PIM data stored on a Bluetooth enabled PDA 24 or cellular phone 26. It may also be desirable to control the cellular phone 26 from the user interface to provide hands free phone operation. It may also be desirable to receive streaming audio from an external source such as the MP3 player 28 and play the received music over the interface speakers 20. Alternatively, it may be desirable to stream audio from the interface module to a pair of wireless headphones 30. APIs must be written and integrated with the user interface application software in order to carry out these functions over the Bluetooth network.

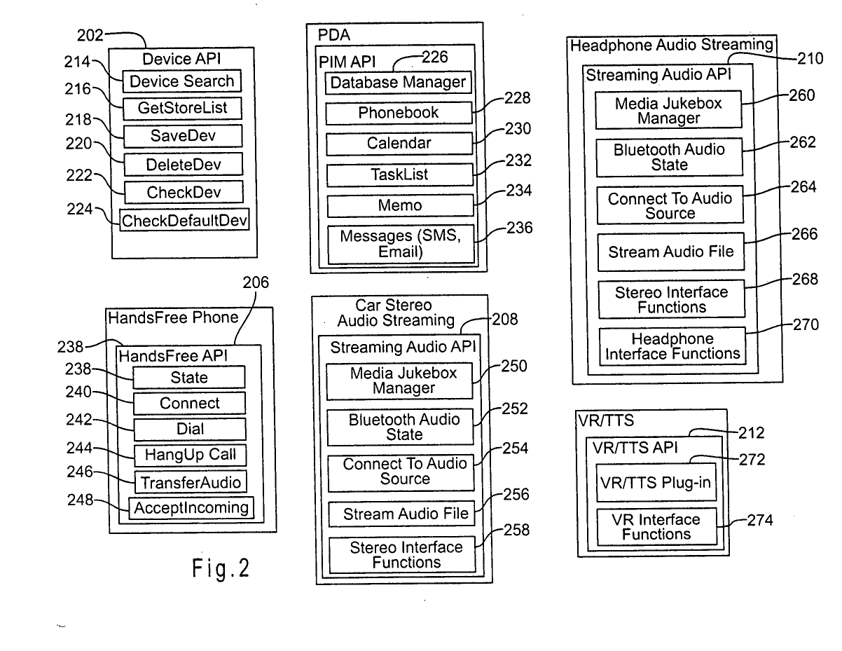

FIG. 2 is a functional block diagram of a plurality of API function modules that may be linked to user interface application program in order to add various wireless Bluetooth communications features to a user interface.

A Devices API module 202 includes function modules adapted to search for and store information related to the Bluetooth devices that comprise the Bluetooth network of which the user interface module is the central component. A user interface application must initialize this information at least once to identify devices that are to be recognized by the network, thereafter, the initialization process need only be activated when the user desires to add a new device, or change an existing device. The Devices API 202 includes instructions and computer executable code operable to execute communication sessions with the devices, and perform a number of device management functions, such as adding devices to the network, interrogating devices to learn their capabilities, determining device presence, and managing operating system interactions, handshake and data transfer functions, parsing Service Discovery Protocol (SDP) records, and memory access functions associated with the devices.

The Device API module 202 may include function modules such as a Device Search module 214, a GetStoredList module 216, a SaveDev module 218, a DeleteDev module 220, a CheckDev module 222, and a CheckDefaultDev module 224 and others. The Device Search module 214 includes functions adapted to initiate a search for the presence of Bluetooth devices. The GetStoredList module 216 includes functions adapted to retrieve a list of stored devices. The SaveDev module 218 includes functions adapted to save a device as a member of the Bluetooth network, and to identify the device as the default device for various functions. The DeleteDev module 220 includes functions to delete a device from the list of networked devices. The CheckDev module 222 includes functions for determining the availability of a device. The CheckDefaultDev module 224 includes functions adapted to check for the availability of the default device for performing a particular function.

The PIM API 204 includes functions for storing data in and retrieving data from a PIM database. The PIM API further includes functions for synchronizing PIM data with external devices. The PIM API 204 includes a Database Manager 226 and function modules configured to allow access to PIM application modules, such as a Phonebook API 2238 a Calendar API 230, a TaskList API 232, a Memo API 234, and a Messages API 236. The Database Manager 226 can interface with both the PIM database of the user interface and external devices via the Bluetooth layer, and thus manage the PIM application in a 4-way server-client-server-client model.

A HandsFree Phone API 206 provides access to Bluetooth functions needed to provide handsfree operation of a cellular telephone through the user interface. The HandsFree phone API module 206 includes a HandsFree State module 238, a HandsFree Connect module 240, a HandsFree Dial module 242, a HandsFree HangUpCall module 244, a HandsFree TransferAudio module 246, and a HandsFree AcceptIncoming module 248. Other function modules within the HandsFree API module 231 are possible. The HandsFree State module 238 includes functions adapted to request the current status of a Bluetooth enables cell phone. The HandsFree Connect module 240 includes functions adapted to request a connection to the cellular phone. The HandsFree Dial module 242 includes functions adapted to request a number to be dialed from the cellular phone. The Handsfree HangUpCall module 244 includes functions adapted to send a hang-up request to the cellular. The HandsFree TransferAudio module 246 includes functions adapted to request handsfree “audio-transfer” from the currently connected and active handsfree cellular phone. The HandsFree AcceptIncoming module 248 includes functions adapted to request a currently connected cellular phone to answer an incoming call.

The Streaming Audio API module 208 provides functions related to streaming media, such as streaming audio files to be played over car stereo speakers. The Car Stereo Audio Streaming API module 208 includes functions for controlling an audio device such as an MP3 player, an audio-enabled PDA, an audio-enabled cellular telephone, or other audio-enabled portable electronic device. The Streaming Audio API module 208 includes function modules such as a Media “Jukebox” Manager 250, a Bluetooth Audio State module 252, a Connect module 254, a Stream module 245, and a Stereo Interface Function module 258.

The Media Jukebox Manager 250 includes functions adapted to manage the formats, locations, availability, and audio parameters of streamable audio located on audio devices interfaced to the Bluetooth network. The Bluetooth Audio State module 252 includes functions adapted to determine the possible states of Bluetooth audio, such as the availability and status of a car stereo (such as whether the car stereo is being used by another device for input/output) and available audio output options, and the like. The Connect to audio source module 254 includes functions adapted to connect an audio-enabled Bluetooth device with another device, such as the car stereo. The Stream audio module 2456 and the Stereo Interface Function module 258 include functions adapted to stream audio and/or video files, such as an MP3, MOV, WMA, WMV or other similar audio/video file for output to the interface speakers.

The Headphone Audio Streaming API module 210 may be configured similarly to the Car Stereo Audio Streaming API module 208, but in reverse, rather than receiving streaming audio from an external source, the Headphone Audio Streaming API 210 may be adapted to stream audio data to an external headphone set. The Headphone Audio Streaming module 210 includes function modules such as Media “Jukebox” Manager 260, a Bluetooth Audio State module 262, a Connect module to audio source 264 and a Stream module 266. A stereo interface functions module 268 and a headphone interface functions module 270.

Finally, the voice recognition/text-to-speech VR/TTS API module 212 allows voice commands to be received and understood by the user interface and provides text translation of the voice input to a display device coupled to the network. The VR/TTS unit also converts text to audible messages that may be played over the interface speakers. The VR/TTS API 212 includes a VR/TTS Plug-in module 262 that provides a voice recognition engine and a text-to-speech engine. A VR Interface Functions module 263 provides functions adapted to configure the VR/TTS API unit as an input module for the user interface.

Other examples of API's dedicated to different functionality or applications are also possible. Other APIs may include a Security API, an OBEX API, a Connection Management API, and a Serial Data API and so forth.

A Software Development Kit (SDK) is provided for allowing user interface developers to develop Bluetooth network APIs for adding Bluetooth wireless communication functionality to user interface modules. The SDK allows the user interface developers to implement API function modules such as those described with in regard to FIG. 2 in a structured framework, and in a manner that allows the developers to add Bluetooth functionality to the user interface modules without having a deep understanding of how Bluetooth communications are implemented. The SDK may include the APIs for managing Bluetooth devices, interfacing a user interface with a PDA, cell phone or other Bluetooth enabled device for synchronizing PIM data, providing hands-free operation of a mobile telephone, receiving streaming audio from a remote source, and streaming audio to a wireless headset or other avoid output device. APIs for providing various Bluetooth functions appear as pre-coded libraries in the SDK. A simplified command syntax allows a user interface developer to select the Bluetooth functions to be included in a user interface from a high level functional perspective, without requser interfacering the developer to delve into the more intricate details of writing the actual code for interfacing the application software with the Bluetooth communication stack. The detailed function calls, handshaking requser interfacerements and other detailed interactions requser interfacered to interact with the Bluetooth stack are abstracted provided by the SDK.

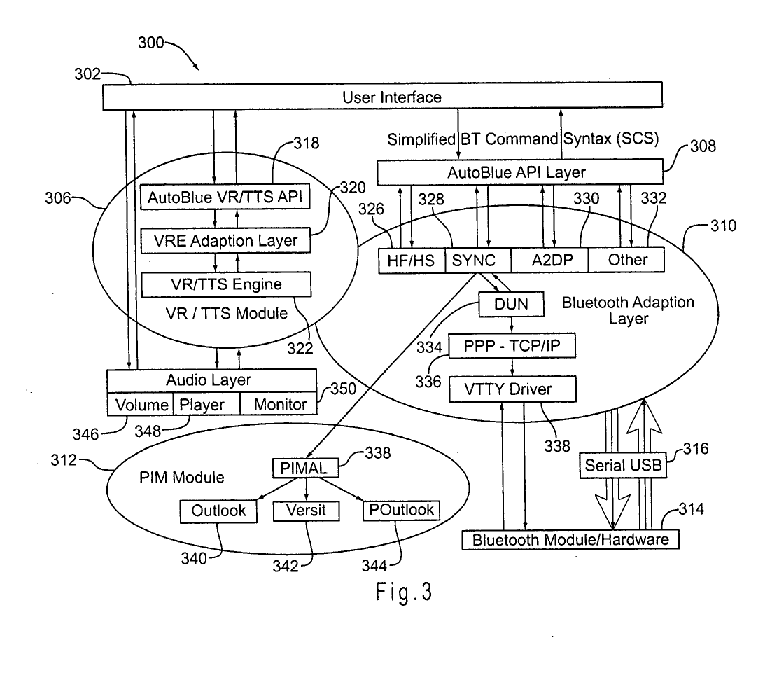

The SDK provides a complete multi-layered software architecture or framework for implementing the network API. A block diagram 300 of the multi-layered architecture is shown in FIG. 3. The software architecture provides the framework for interfacing the functions of a user interface 302 with a Bluetooth module 314. The Bluetooth module 314 may be provided by one of a number of different Bluetooth providers. The Bluetooth Module 314 may include the hardware and software for implementing wireless communications with remote devices according to the Bluetooth protocol. Alternatively, some of the software layers associated with the Bluetooth communications stack may be distributed to other layers of the software architecture 300 such as the Bluetooth adaption layer 310.

The user interface 302 includes hardware and application software for interacting with the input and output devices associated with the user interface. The interface 302 may include an audio layer 304 which is independent of the software architecture provided by the SDK. The audio layer 304 may be provided to manage the audio signals played over and audio sound system associated with the user interface 302. The audio layer includes function for controlling the volume 346, the player or source of audio to be played over the sound system, and a monitor function for monitoring the filesystem for removeable media. The user interface may also include a serial/USB bus 316 for communicating between the Bluetooth module 314 and a Bluetooth adaption layer 310 provided by the SDK.

The multi-layered software architecture of the SDK includes a voice recognition/text-to-speech (VR/TTS) module 306. An API layer 308, the Bluetooth adaption layer 310 and a PIM adaption layer 312. The VR/TTS module 306 interfaces directly with the user interface 302 and the audio layer 304 associated with the user interface 302. The VR/TTS module 306 receives acoustic data from the microphone associated with the user interface 302 and interprets verbal commands spoken by a user. The interpreted commands are returned to the user interface 302 where they are processed executed like any other input commands. The VR/TTS module 306 may also receive text data such as phonebook entry names and song titles. The text-to-speech function converts the received text data into synthesized speech, which may be provided to the audio layer 304, and played over audio speakers associated with the user interface 302. Similarly, audio signals may be received from the audio layer 304 to be interpreted by the VR/TTS module 306.

The SDK provides three interacting software layers within the VR/TTS module. These include a VR/TSS API layer 318, a voice recognition engine (VRE) Adaption Layer 320, and the actual VR/TTS Engine Layer 322. The VR/TTS API Layer includes the voice recognition and text-to-speech function calls for involving the VR/TTS engine. The function calls included in the VR/TTS API are shown in Table 1. The VR/TTS Engine Layer 322 is adapted to include the software for actually performing the voice recognition and text-to-speech operations. The VR/TTS engine may be provided by various voice recognition/text-to-speech software provided the requser interfacerements for interacting with the VR/TTS engine will differ from the VR/TTS supplier to another. However, the VR/TTS function calls and data transfer protocols of the VR/TTS API exposed by the SDK are intended to be generic to any and all VR/TTS engines. The VRE adaptation layer 320 is provide to receive mapping instructions for converting and adapting the generic function calls of Table 1 to particular requser interfacerements of the selected VR/TTS engine. The SDK may include several sets of pre-coded VRE mapping instructions for mapping the VR/TTS API layer to the voice recognition engines of lending VR/TTS providers. A user interface developer may simply select the appropriate set of mapping instructions corresponding to the VR/TTS engine selected for the application using the simplified command syntax employed by the SDK. Alternatively the user interface developer may create its own set of mapping instructions to be inserted into the VRE adaption layer 320 in order to map the VR/TTS API function calls and data transfer protocols to a particular VR/TTS engine not supported by the SDK. With this arrangement a user interface developer may easily switch between VR/TTS engines supplied by different VR/TTS software providers with negligible impact on the overall structure of the interface software.

TABLE 1

| VR/TTS | FUNCTION CALLS |
|---|---|
| VRI | Init( ) |
| VRI | Release( ) |
| VRI | Speak( ) |
| VRI | Recognize( ) |
| VRI | AddPhase( ) |
| VRI | DeletePhese( ) |
| VRI | EnableGrammar( ) |
| VRI | Enroll( ) |
| VRI | Cancel( ) |

Table 2 Example Simplified Command Syntax

The API Layer 308 interacts with the Bluetooth adaption layer 310, and through the Bluetooth adaption layer 310 with the Bluetooth module 314 in a manner similar to the manner in which the VR/TTS API Layer 318 interacts with the VR/TTS engine 322 within the VR/TTS module 306. The API layer 308 interacts directly with the user interface 302. The API Layer receives commands from and exchanges data with the user interface 302 according to the input commands entered into the interface. The API layer 308 includes the various API function modules provided by the SDK for providing Bluetooth communication to the user interface 302. For example, the API layer may include the APIs described in relation to FIG. 2, including the Devices API 202, the PIM API 204, the Hands-free Phone API 206, the Car Stereo Audio Streaming API 208, and the Headphone Audio Streaming API 210. The function calls and data transfer protocols associated with the APIs in the API layer 308 are generic. The API must be mapped to the particular function call and data transfer protocols of the particular Bluetooth module 314 employed in the interface module. The SDK may include multiple sets of mapping instructions for mapping the API function calls and data transfer protocols to the requser interfacerements of many leading Bluetooth suppliers. Furthermore, the Bluetooth adaption layer 310 may include specific mapping functions for implementing specific Bluetooth profiles including HF/HS (Handsfree/Headset), mapping instructions 326 for handsfree telephone operation; sync mapping instructions 328 for implementing PIM data synchronization functions; advanced audio distribution profile 330 for receiving streaming audio; and other mapping functions 332. The Bluetooth adaption layer 310 further implements various higher level communications protocols for communicating with external devices over the Bluetooth network. For example, the Bluetooth adaption layer may include software implementing dial up networking (DUN) 334, point-to-point protocol (PPP) and Transmission Control Protocol/Internet Protocol (TCP/IP) 336 and a Virtual Serial Port Driver (VTTY Driver) 338.

As with the VR/TTS module, the mapping requser interfacerements for mapping the APIs exposed in the API layer 305 to the specific Bluetooth commands of the particular Bluetooth module employed in the user interface will change depending on the Bluetooth module employed. The SDK may include multiple sets of mapping instructions for mapping the API function calls and data transfer requser interfacerements to the Bluetooth stacks of most major Bluetooth providers. A user interface developer may simply select the appropriate set of mapping instructions corresponding to the particular Bluetooth module selected for the application, and initiate the necessary functions via the simplified command syntax employed by the SDK. Alternatively, the user interface developer may write its own set of mapping instructions to interface with a Bluetooth stack not supported by the SDK. With its arrangement the user interface developer need only swap out the mapping instruction set stored in the Bluetooth adaption layer in order to implement all of the Bluetooth functions enabled via the API layer 308 on a Bluetooth stack provided by a different Bluetooth provider.

The PIM module 312 offers similar flexibility. The PIM module 312 may employ a commercially available PIM database. For example, the user interface may employ MS Outlook 340, Pocket Outlook 344, or some other non-proprietary PIM database such as a simple text database using Versit (VCARD/VCAL) format, 342. Different databases retrieve and store PIM data in different ways. Thus, the generic commands for saving and retrieving data associated with the PIM API exposed in the API layer 308 and the protocols for synchronizing the data stored in the PIM database with PIM data stored on external devices exposed in the Bluetooth adaption layer 310 must be mapped to the interface requser interfacerements of the particular PIM database employed by the PIM module 312. Therefore, like the VR/TTS module the PIM module 312 includes a PIM adaption layer 338 adapted to receive a set of mapping instructions for mapping the various data store and retrieve commands from the PIM API to the particular PIM database employed in the PIM module 312. The SDK may include multiple sets of mapping instructions for mapping the PIM data store and retrieve commands and data synchronization functions for most prominent PIM databases. A user interface developer may then simply select the appropriate set of mapping instructions corresponding to the particular PIM database employed in the application, and activate the necessary data store, retrieve, and synchronization functions via the SDK simplified command syntax. Alternatively, the user interface developer may write its own set of mapping instructions to interface with a PIM database not supported by the SDK. With this arrangement the user interface developer need only swap out the PIM mapping instruction set in the PIM adaption layer 338 in order to implement an interface using a different PIM database.

It should be noted that according to the architecture 300 shown in FIG. 3, the PIM adaption layer 338 does not interact with the API layer 302 but rather the sync function 328 of the Bluetooth adaption layer 310. The data synchronization function is initiated through the user interface 302 via the PIM API exposed in the API layer 308. However, the synch protocols such as syncML IRMC and the like, necessary to sync multiple devices are included in the Bluetooth layer 301. Thus, interface functions that rely on the PIM database are invoked all three layers of the SDK architecture, the API layer, the Bluetooth adaption layer and the PIM module 312.

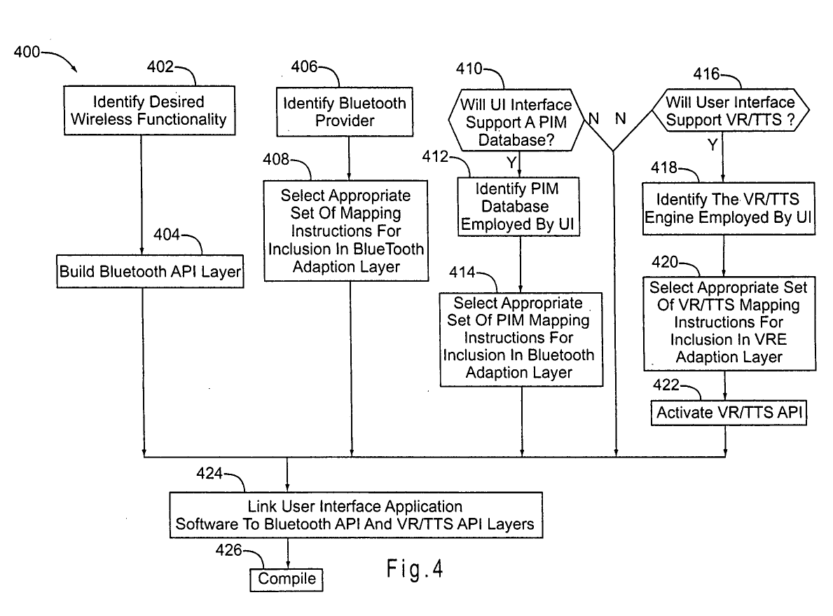

FIG. 4 is a flowchart 400 illustrating a process of developing a Bluetooth enabled user interface application using the SDK. The process includes a number of sub-processes that may be performed in parallel or serially in substantially any order at the user interface developer's discretion. At 402 the user interface developer specifies a plurality of network communications functions that are to be provided by the user interface wireless communications network. Examples of the desired network communications functions may include: connecting or accepting incoming Bluetooth connections, creating security bonds between devices, and controlling devices specific functionality such as making/receiving phone calls, streaming media, and/or manipulation/synchronization/retrieval of personal data. A user may specify a plurality of data retrieval functions requser interfacered for the user interface application module to interact with devices coupled to the wireless communications network. For example, data retrieval functions may include operating system interaction functions, handshake and data transfer functions, and memory access functions associated with the devices, and the like.

After specifying the network communications functions at 402, the user interface developer may buser interfaced the API layer at 412 by specifying the desired API functions using the simplified command syntax provided by the SDK. Simplified Command Syntax provides a library of pre-coded API function modules. The function modules defined by the simplified command systax encompass the more detailed function calls and administrating functions that must be performed to effectively interact with the Bluetooth stack. The API function modules provide a level of abstraction from the Bluetooth layer, allowing a network developer to implement the desired Bluetooth communication functions without having detailed knowledge of the underlying Bluetooth network functions. The network APIs may be in the form of computer executable source code such as ANSIIC. Using the simplified command syntax the user interface developer specifies which API functions will be exposed in the API layer, and thus, which Bluetooth communications functions will be available to the user interface when the user interface module is compiled. The API function modules specify how requests to devices or network modules are implemented.

TABLE 2
Example Simplified Command Syntax
Table 2 below provides a list of function modules that may be exposed
in the API layer according to the Simplified Command Syntax:

| Simplied Command Syntax Function | Description |
|---|---|
| AB_USER_Destroy( ) | Destroys the USER Module and |
| | releases any allocated memory used |
| AB_USER_Init( ) | Initializes the USER Module |
| ABAPI_Configure( ) | Re-configures the AutoBlue API |
| | Wrapper Module |
| ABAPI_Destroy( ) | Releases any memory/resources held |
| | by the AutoBlue components |
| ABAPI_DEV_CheckDev( ) | Requests that AutoBlue check for the |
| | availability of a device |
| ABAPI_DEV_DefA2dpSrc( ) | |
| ABAPI_DEV_DefPhone( ) | |
| ABAPI_DEV_DeleteDev( ) | Requests that AutoBlue delete the |
| | device |
| ABAPI_DEV_GetStoredList( ) | Requests that the bluetooth |
| | application inform of stored devices |
| ABAPI_DEV_SaveDev( ) | Requests that AutoBlue save the |
| | device as the default device for all |
| | functionality |
| ABAPI_DEV_Search( ) | Requests that AutoBlue issue an |
| | inquser interfacery for a bluetooth |
| | device |
| ABAPI_DEV_SetDefaultDev( ) | Requests that AutoBlue set the device |
| | as the default device for all |
| | functionality |
| ABAPI_GetConfig( ) | Retrieves the current AutoBlue |
| | Platform configuration |
| ABAPI_HF_AcceptIncomingCall( ) | Requests a currently connected phone |
| | to answer an incoming call |
| ABAPI_HF_Connect( ) | Requests a connect to the most |
| | recently used (i.e. the default) |
| | handsfree phone |
| ABAPI_HF_Dial( ) | Requests a number to be dialed from |
| | the currently connected handsfree |
| | phone |
| ABAPI_HF_Disconnect( ) | Requests a disconnect from the |
| | currently connected handsfree phone |
| ABAPI_HF_HangUpCall( ) | Requests that a hang-up request be |
| | sent to a currently connected and |
| | active handsfree phone |
| ABAPI_HF_Redial( ) | Requests a number to be re-dialed |
| | from the currently connected |
| | handsfree phone |
| ABAPI_HF_RejectIncomingCall( ) | Requests a currently connected phone |
| | to reject an incoming call |
| ABAPI_HF_State( ) | Requests the current handsfree status |
| ABAPI_HF_TransferAudio( ) | Requests a handsfree “audio-transfer” |
| | from the currently connected and active |
| | handsfree phone |
| ABAPI_Init( ) | Initializes the AutoBlue Integration API |
| ABAPI_PIM_Calendar( ) | Calendar object array |
| ABAPI_PIM_CalItem( ) | Returns a pointer to a calendar |
| | structure with the specified INDEX |
| ABAPI_PIM_CalItemById( ) | Returns a pointer to a calendar |
| | structure with the specified ID |
| ABAPI_PIM_DeleteCal( ) | Requests that all calendar events be |
| | deleted from the AutoBlue PIM |
| | Database |
| ABAPI_PIM_DeleteCalItem( ) | Requests that a calendar event be |
| | deleted from the AutoBlue PIM |
| | Database |
| ABAPI_PIM_DeletePb( ) | Requests that all phonebook items be |
| | deleted from the AutoBlue PIM Database. |
| ABAPI_PIM_DeletePbItem( ) | Requests that a contact be deleted |
| | from the AutoBlue PIM Database |
| ABAPI_PIM_FilterCalendar( ) | Requests a re-sorting of the calendar |
| | object array |
| ABAPI_PIM_FilterPhonebook( ) | Requests a re-sorting of the |
| | phonebook object array |
| ABAPI_PIM_FormattedNumber( ) | Returns a pointer to a string containing |
| | a formatted phone number |
| ABAPI_PIM_GetCalendar( ) | Requests that AutoBlue module send |
| | the current contents of the PIM's |
| | calendar object |
| ABAPI_PIM_GetPhonebook( ) | Requests that AutoBlue module send |
| | the current contents of the PIM's |
| | phonebook object |
| ABAPI_PIM_GetStatus( ) | Requests that the sync status be |
| | broadcast onto the interface bus |
| ABAPI_PIM_GetSyncMLParams( ) | Requests that the user's remote |
| | SyncML account information be updated |
| ABAPI_PIM_LockCalendar( ) | Locks the Integration Library from |
| | reading/writing the calendar memory |
| ABAPI_PIM_LockPhonebook( ) | Locks the Integration Library from |
| | reading/writing the phonebook |
| | memory |
| ABAPI_PIM_NumCalItems( ) | Requests the number of calendar |
| | items/events currently stored in memory |
| ABAPI_PIM_NumPbItems( ) | Requests the number of phonebook |
| | items currently stored in memory |
| ABAPI_PIM_NumPhoneNumbers( ) | Returns the number of phone numbers |
| | that the specified phonebook item has |
| ABAPI_PIM_PbItem( ) | Returns a pointer to a phonebook |
| | structure with the specified INDEX |
| ABAPI_PIM_PbItemById( ) | Returns a pointer to a phonebook |
| | structure with the specified ID |
| ABAPI_PIM_Phonebook( ) | The phonebook object array |
| ABAPI_PIM_PhoneNumberTypes( ) | Returns the types of phone number |
| | that are recorded for the specified |
| | phonebook item |
| ABAPI_PIM_SaveCalItem( ) | Requests that the given calendar |
| | event be added/updated in the |
| | AutoBlue PIM database |
| ABAPI_PIM_SaveCalItems( ) | Requests that the given calendar |
| | event(s) be added/updated in the |
| | AutoBlue PIM database |
| ABAPI_PIM_SavePbItem( ) | Requests that the given contact be |
| | added/updated in the AutoBlue PIM |
| | database |
| ABAPI_PIM_SavePbItems( ) | Requests that the given contact(s) be |
| | added/updated in the AutoBlue PIM |
| | database |
| ABAPI_PIM_Set4WaySync( ) | Requests a re-sorting of the calendar |
| | object array |
| ABAPI_PIM_SetSyncMLParams( ) | Requests that the user's remote |
| | SyncML account information be |
| | updated |
| ABAPI_PIM_Sync( ) | Requests that synchronization start |
| | with the user's default synchronization |
| | device |
| ABAPI_PIM_SyncCal( ) | Requests that synchronization start |
| | with the user's default synchronization |
| | device, sync calendar only |
| ABAPI_PIM_SyncPb( ) | Requests that synchronization start |
| | with the user's default synchronization |
| | device, sync phonebook only |
| ABAPI_PIM_SyncPDA( ) | Requests that synchronization start |
| | with a PDA |
| ABAPI_PIM_UnformattedNumber( ) | Returns a pointer to a string containing |
| | an unformatted phone number |
| ABAPI_PIM_UnlockCalendar( ) | Unlocks the read/write lock on the |
| | calendar memory |
| ABAPI_PIM_UnlockPhonebook( ) | Unlocks the read/write lock on the |
| | phonebook memory |
| ABAPI_USER_Create( ) | Creates a new AutoBlue bluetooth user profile |
| ABAPI_USER_Switch( ) | |

At 406 the user interface developer identifies the Bluetooth module that will be included in the user interface module. Because the Bluetooth communications stacks of different Bluetooth providers have their own peculiarities regarding function calls and data transfer protocols, the selection of the particular Bluetooth module to be included in the user interface module will drive the selection of the mapping instructions to be included in the Bluetooth adaption layer at 408. Selection of the appropriate mapping instructions at 406 may also include selection of higher level transport protocols for implementing desired communications functions.

The user interface developer determines whether the user interface will support a PIM database. If so, the user interface developer identifies the PIM back end database that will be included in the user interface module at 410. The user interface developer must then select the appropriate set of PIM mapping instructions to be included in the PIM adaption layer at 412. The user interface developer may also specify the desired PIM synchronization functions for synchronizing the PIM data stored on an internal PIM database and PIM data stored on external data storage devices at 410. The PIM synchronization functions may include identifying data records and data storage locations containing PIM data, and identifying protocols available on the external devices for updating, modifying, and tracking changes to PIM data. Since the user interface developer may not know what devices the user interface may be interacting with, the user interface developer may specify sync protocols and architecture options and routines for selecting the appropriate protocols so that the user interface may interoperate with a plurality of other devices. In other words, the user interface developer specify network level functional modules and device-specific functional modules. If the user interface will not be supporting a PIM database as determined at 108, the activities described as 410 and 412 may be bypassed.

At 416 the user interface developer determines whether the user interface will support voice recognition and text-to-speech functionality. At 418 the user interface developer identifies the VR/TTS engine that will be employed by the user interface. Based on the identified VR/TTS engine the user interface developer selects the appropriate set of VR/TTS mapping instructions to be included in the VRE adaption layer at 420, at 422 the user interface developer activates the VR/TTS API provided by the SDK.

For example, if an application module needs to initiate a data transfer between a portable electronic device in the Bluetooth network and the PIM database associated with the user interface module, network APIs are operable to accept, bind, and connect to the appropriate sockets needed to complete the communication between the external device and the PIM database devices.

The APIs exposed in the API layer will define the Bluetooth functionality available to the user interface. For example, depending on which APIs are exposed, the user interface may implement functions such as handfree telephony, PIM synchronization, and audio streaming. Exposing the pre-coded APIs via the simplified command syntax allows these functions to be implemented without user interface detailed knowledge of the underlying Bluetooth network functions. All of this occurs without the user interface developer's involvement. All that is user interface of the developer is to specify the desired functions, and the pre-coded API modules take care of the underlying details. The user interface application program is linked to the API layer, as well as the VR/TTS module, at 424 by adding the appropriate function calls to the Bluetooth APIs and the VR/TTS API in the VR/TTS API layer. The user interface application program, including the desired Bluetooth wireless communications functionality may then be compiled at 426 and loaded into the program memory of the user interface module.

Once installed, the user interface application allows a user to input data, instruct external devices to perform desired functions, and receive data from the external devices within the network. The user interface application module is operable to process user-input instructions to access the Bluetooth network, initiate data synchronization operations between devices in the Bluetooth network, and access PIM data associated with the various devices. Using the SDK, the user interface application module is linked to the network API when the user interface application module is compiled. The user interface developer compiles SDK layers for a specific target platforms and links the SDK layers to the user interface application module. The user interface application module includes header files and callback implementations in the user interface code. If the link between the user interface application module and the network API user interface a static link, the developer compiles the network API and the user interface application program, and links them at build time. If the link between the user interface application program and the network API requires a dynamic link, at act 410, the developer may compile the network API and user interface application and links them.

Various applications may be created using the software development kit and the process described in FIG. 4. For example, a developer may implement a streaming audio application using the SDK described above. The developer may be able to access data transfer functions contained in the API to stream MP3 or other audio-format files between devices. The SDK allows a user interface developer to create application modules, in software or hardware, that access wireless network functions without requiring detailed knowledge of the underlying network protocols and commands. Thus SDK may allow rapid application development in a vehicle-based Bluetooth environment, such as telematics platforms.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A software tool for implementing an application program interface (API) adding Bluetooth wireless functionality to a user interface module, the software tool comprising:
a layered framework defining a plurality of interacting functional layers for communicating data and commands between the user interface module and a Bluetooth communications stack;
a plurality of pre-coded API function modules for implementing interface functions;
a plurality of pre-coded Bluetooth function mapping instruction sets; and
a simplified command syntax for identifying and selecting pre-coded API function modules and a pre-coded Bluetooth interface function mapping instruction set to be included in the various functional layers of the layered framework according to the interface functions to be performed by the user interface module.

2. The software tool of claim 1 wherein the layered framework includes an API layer adapted to receive one or more pre-coded API function modules.

3. The software tool of claim 2 wherein the pre-coded API function modules included at least one of: a devices API module; a Personal Information Management Module (PIM) API; a Car Stereo Streaming Audio API module; a Hands Free Phone API module; or a Voice Recognition/Text-To-Speech API module.

4. The software tool of claim 1 wherein the layered framework includes a Bluetooth adaption layer configured to receive one of a plurality of pre-coded Bluetooth interface function mapping instruction sets, the selected Bluetooth function mapping instruction set adapted to map function calls from selected API function modules to Bluetooth commands associated with a specified Bluetooth stack included in the user interface module.

5. The software tool of claim 1 wherein the layered framework further includes a personal information management module (PIM) adaption layer configured to receive a PIM instruction set adapted to interface with a specified PIM database.

6. The software tool of claim 1 further comprising a voice recognition/text-to-speech API and a voice recognition engine adaption layer, the voice recognition adaption layer configured to receive software instructions adapted to execute functions called for by the voice recognition/text-to-speech API on a specified voice recognition/text-to-speech engine.

7. A method of implementing an application program interface (API) to add Bluetooth wireless functionality to a user interface module, the API having a multi-layered functional architecture for communicating interface commands and data between the user interface module and a Bluetooth stack, the multi-layered functional architecture including an API layer configured to implement one or more interface functions via the Bluetooth stack, a Bluetooth adaption layer configured to implement software instructions for mapping interface commands and data between the API layer and the Bluetooth stack, and a personal information management (PIM) module adaption layer configured to implement software instructions for mapping PIM commands and data between the API layer and a PIM database associated with the user interface module, the method comprising:
selecting API functions from a library of pre-coded API function modules adapted to provide one or more interface functions for interacting with an external device and including the selected API function modules in the API layer;
selecting a set of pre-coded mapping instructions for mapping Bluetooth function calls from the API function modules to the Bluetooth stack, the mapping instructions adapted to interface with the Bluetooth stack employed in the user interface module, and inserting the set of mapping instructions in the Bluetooth adaption layer;
selecting a set of pre-coded PIM mapping instructions for mapping PIM commands from a PIM API to a PIM database, and inserting the selected set of PIM mapping instructions in the PIM adaption layer.

8. The method of claim 7 wherein the library of pre-coded API function modules comprises at least one of: a devices API adapted to manage external Bluetooth enabled devices adapted to communicate with the user interface module; a PIM API adapted to synchronize PIM data stored on the PIM database with PIM data stored on an external device; a hands free phone API for controlling a cellular telephone via the user interface module; a car stereo audio streaming API for receiving streaming audio data from an external device to be played back via an audio layer associated with the user interface module; a headphone audio streaming API for streaming audio data from the user interface module to an external wireless headphone set; or a voice recognition/text-to-speech API.

9. A software development kit for implementing an application program interface (API) adding Bluetooth wireless functionality to a user interface module, the software development kit comprising:
a plurality of pre-coded function modules;
a layered functional architecture for organizing interactions between software components of the API; and
a simplified command syntax for selecting pre-coded software modules to be added to the various layers of the layered architecture to provide desired Bluetooth wireless functionality to the user interface module.

10. The software development kit of claim 9 wherein the simplified command syntax comprises a limited set of functional commands abstracted from a larger set of Bluetooth commands such that a simplified command syntax command encompasses all of the corresponding Bluetooth commands necessary to carry out a function associated with the simplified command syntax command.

11. The software development kit of claim 9 wherein the layered architecture comprises an API layer for receiving selected pre-coded function modules for implementing specified interface functions.

12. The software development kit of claim 11 wherein the layered architecture further comprises a Bluetooth adaption layer adapted to receive a set of mapping instructions for mapping function calls from the selected pre-coded function modules in the API layer to Bluetooth function calls adapted to interact with a Bluetooth stack from a specified Bluetooth supplier.

13. The software development kit of claim 12 wherein the layered architecture further comprises a personal information management (PIM) adaption layer adapted to receive a set of mapping instructions for mapping PIM commands and data between a PIM database associated with the user interface module and an external device.

14. The software development kit of claim 10 wherein the layered architecture further comprises a personal information management (PIM) adaption layer adapted to receive a set of mapping instructions for mapping PIM commands and data between a PIM database associated with the user interface module and an external device.

15. The software development kit of claim 9 wherein the plurality of pre-coded function modules comprises a PIM API module.

16. The software development kit of claim 9 wherein the plurality of pre-coded function modules comprises a Devices API for managing Bluetooth devices.

17. The software development kit of claim 9 wherein the plurality of pre-coded function modules comprises a Hands Free Phone API module.

18. The software development kit of claim 9 wherein the plurality of pre-coded function modules comprises a Car Stereo Audio Streaming API module.

19. The software development kit of claim 9 wherein the plurality of pre-coded function modules comprises a Headphone Audio Streaming API module.

20. A software architecture for implementing an application programming interface for providing Bluetooth wireless communications functionality to a user interface, the software architecture comprising:
an API layer adapted to expose API modules implementing specific wireless communication functions to a user interface application program, the API modules adapted to receive input commands and data from and send output data to the user interface, and to interact with external devices via a wireless Bluetooth link;
a Bluetooth adaption layer adapted to include mapping instructions for mapping generic Bluetooth function calls from the API modules of the API layer to specific Bluetooth commands associated with a specified Bluetooth stack.

21. The software architecture of claim 20 further comprising a plurality of different sets of Bluetooth function mapping instructions corresponding to Bluetooth communications stacks provided by different Bluetooth providers such that a particular set of Bluetooth function mapping instructions may be selected to be included in the Bluetooth adaption layer according to the particular Bluetooth communications stack included in the user interface module.

22. The software architecture of claim 21 wherein the plurality of pre-coded function modules comprises a PIM API module.

23. The software development kit of claim 21 wherein the plurality of pre-coded function modules comprises a Devices API for managing Bluetooth devices.

24. The software development kit of claim 21 wherein the plurality of pre-coded function modules comprises a Hands Free Phone API module.

25. The software development kit of claim 21 wherein the plurality of pre-coded function modules comprises a Car Stereo Audio Streaming API module.

26. The software development kit of claim 21 wherein the plurality of pre-coded function modules comprises a Headphone Audio Streaming API module.

27. A software architecture for implementing an application programming interface (API) for providing Bluetooth wireless communications functionality to a user interface, the software architecture comprising:
an application programming interface layer adapted to include API modules implementing specific wireless communication functions, the API modules adapted to receive input commands and data from, and provide output data to, the user interface, and to interact with external devices via a Bluetooth link;
a PIM adaption layer adapted to include mapping instructions for mapping data and commands between the API modules and external devices and a specified PIM database included with the user interface module.

28. The software architecture of claim 27 further comprising a plurality of different sets of PIM mapping instructions for mapping PIM commands and data between the API modules and external devices and different types of PIM databases such that a particular set of PIM mapping instructions may be selected to be included in the PIM adaption layer according to the particular type of PIM database included in the user interface module.

29. The software development kit of claim 28 wherein the plurality of pre-coded function modules comprises a PIM API module.

30. The software development kit of claim 28 wherein the plurality of pre-coded function modules comprises a Devices API for managing Bluetooth devices.

31. The software development kit of claim 28 wherein the plurality of pre-coded function modules comprises a Hands Free Phone API module.

32. The software development kit of claim 28 wherein the plurality of pre-coded function modules comprises a Car Stereo Audio Streaming API module.

33. The software development kit of claim 28 wherein the plurality of pre-coded function modules comprises a Headphone Audio Streaming API module.

34. A software architecture for implementing an API for providing Bluetooth wireless communications functions on a user interface module, the software architecture comprising:
an API layer adapted to hold a plurality of API function modules adapted to implement various Bluetooth functions;
a Bluetooth adaption layer adapted to hold mapping instructions for mapping Bluetooth function calls from the various function modules in the API layer to a Bluetooth stack, the Bluetooth adaption layer adapted to receive alternative sets of mapping instructions to map the API function calls to Bluetooth stacks provided by different Bluetooth providers.

35. The software development kit of claim 34 wherein the plurality of pre-coded function modules comprises a PIM API module.

36. The software development kit of claim 34 wherein the plurality of pre-coded function modules comprises a Devices API for managing Bluetooth devices.

37. The software development kit of claim 34 wherein the plurality of pre-coded function modules comprises a Hands Free Phone API module.

38. The software development kit of claim 34 wherein the plurality of pre-coded function modules comprises a Car Stereo Audio Streaming API module.

39. The software development kit of claim 34 wherein the plurality of pre-coded function modules comprises a Headphone Audio Streaming API module.

40. A method of implementing a wireless communications API for providing Bluetooth wireless communication functions in a user interface module, the method comprising:
creating a multi-layered software architecture for communicating commands and data between a user interface and a Bluetooth stack, the multi-layered architecture including an API layer and a Bluetooth adaption layer;
creating a plurality of pre-coded API function modules for providing various wireless communication functions, the pre-coded API function modules including various generic Bluetooth function calls for communicating commands and data between the user interface module and external devices;
creating a plurality of Bluetooth adaption instruction sets for mapping the generic function calls of the pre-coded API function modules to specific Bluetooth communication stacks; and
providing a simplified command syntax allowing a user interface developer to select API function modules to be included in the wireless communications API, and a Bluetooth adaption instruction set based on a specified Bluetooth stack.

41. The method of claim 40 wherein the user interface module includes a personal information management (PIM) database, and the multi-layered architecture further includes a PIM adaption layer, the method further comprising providing a plurality of PIM adaption instruction sets for mapping generic PIM function calls and data from a pre-coded PIM function module to the PIM database, and selecting a PIM adaption instruction set based on the type of PIM database included in the user interface module.

42. The method of claim 41, wherein implementing a plurality of API function modules includes implementing a PIM synchronization API for synchronizing PIM data stored on the PIM database of the user interface with PIM data stored on an external device via a Bluetooth wireless communication.

43. The method of claim 42, wherein the external device is a personal digital assistant.

44. The method of claim 42, wherein the external device is a cellular telephone.

45. The method of claim 40 wherein implementing a plurality of API function modules includes implementing a hands free phone API for operating a cellular telephone through the user interface via a Bluetooth wireless connection.

46. The method of claim 40 wherein implementing a plurality of API function modules includes implementing a Devices API adapted to manage a plurality external devices adapted to communicate with the user interface over a Bluetooth wireless link.

47. The method of claim 40 wherein implementing a plurality of API function modules includes implementing a Car Stereo Audio Streaming Audio API for receiving streaming audio from an external source over a Bluetooth wireless link to be playing over an audio playback layer associated the user interface module.

48. The method of claim 40 wherein implementing a plurality of API function modules includes implementing a Headphone Audio Streaming API for streaming audio from an audio playback layer associated with the user interface to an external headphone set over a Bluetooth wireless link.
